(19) United States
(12) Patent Application Publication
(10) Pub. No.: US 2004/0008972 A1
(43) Pub. Date: Jan. 15, 2004

(54) Personal TV receiver (PTR) with program recommendation forwarding function

(75) Inventor: Jack E. Haken, Danbury, CT (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 09/821,121

(22) Filed: Mar. 29, 2001

(51) Int. Cl. H04N 5/76; G06F 3/00; G06F 13/00

(52) U.S. Cl. 386/83; 725/58

(57) ABSTRACT

A programmable TV recorder stores computer readable instructions for programming a processor to monitor an input port capable of receiving schedule and software updates for a recommendation, to extract a username from the recommendation, to compare the extracted username to a stored usernames, and to output the recommendation to a list when the processor determines that the stored usernames include the extracted username.

### BACKGROUND OF THE INVENTION

1. Field of the Invention

The present invention relates generally to a personal TV receiver (PTR). More specifically, the present invention relates to an improved PTR having functions for forwarding and receiving recommendations regarding programs to be recorded. Corresponding methods and software stored in a memory for permitting the PTR to generate and/or respond to recording recommendations are also disclosed.

2. Background of the Invention

A new type of consumer electronics product known by several names including a Personal Television Receiver (PTR), digital video recorder (DVR) or, simply, a disk buffered television (DBT), has recently been introduced into the home entertainment products market. A PTR is designed to replace or augment the family's conventional VCR by recording television to an internal hard drive instead of onto a tape.

The PTR is connected to both a video source, e.g., an antenna, a cable television system, a satellite receiver, etc., and a PTR service provider. More specifically, the PTR incorporates a modem that permits the PTR to connect to a central server via a telephone line. The communication channel thus established is used to download program schedules and operating software revisions on a regularly scheduled basis, e.g., daily. Since each PTR can be connected to a variety of video sources, the user registers the PTR with the service provider and provides the service provided with detailed information regarding the video source employed by the user. Thus, the PTR can download schedule updates keyed to one and only one video source.

The PTR advantageously possesses smart technology, which permits the PTR to employ the downloaded schedule, and user specified preferences to implement recording preferences. In other words, the smart search technology incorporated into the PTR permits the user to specify a preference list, which the PTR uses to find and record every show that features the user's favorite actor or sports team, topic of interest, etc.

Each PTR has a unique electronic serial number, which can be transmitted to the server each time that the PTR connects to download schedule and software updates. The serial number is provided to the server to identify the PTR to the server, e.g., to verify that the PTR corresponds to an authorized subscriber to the service, and to identify the specific information that the PTR needs to download. The PTR has the capability to record and upload user viewing statistics to the server.

It will be appreciated that programming the PTR to record a particular event or an addition to the user's preference list is a local operation. Thus, if the user forgets to schedule a particular event, e.g., the user learns that his/her child will be on a local news program, while the user is away from his/her PTR, the user will be unable to record the event What is needed is an operating method and corresponding structure, which will permit a PTR to receive changes to a recording schedule transmitted from a remote location. What is also needed is a method and corresponding structure which permit will permit the owner of a first PTR to communicate recommended recording events to other owners of PTRs. What is also needed is a method and corresponding structure which permits the PTR to be programmed any client device, i.e., a computer, personal digital assistant (PDA), e-mail capable cell phone, etc. Beneficially, the method permits the PTR to accept remote commands using known verification schemes.

### SUMMARY OF THE INVENTION

According to one aspect, the present provides a memory associated with a programmable TV recorder storing computer readable instructions for programming a processor to monitor an input port capable of receiving schedule and software updates for a recommendation, to extract a username from the recommendation, to compare the extracted username to a stored usernames, and to output the recommendation to a list when the processor determines that the stored usernames include the extracted username. In an exemplary case, the list includes the recording schedule. In another exemplary case, the list includes a recommendation list that can be output for display by the programmable TV recorder under control of the processor. If desired, the stored usernames can include both a first group and a second group of stored usernames, the first group and second group being mutually exclusive, while the list includes both a recording schedule and a recommendation list that can be output for display by the programmable TV recorder under control of the processor, in that case, the recommendation is output to the recording schedule when the extracted username is in the first stored group of usernames and the recommendation is output to the recommendation list when the extracted username is in the second stored group. In the latter case, the first stored usernames are distinguished from the second stored usernames by a flag associated with each of the first and second stored usernames.

According to another aspect, the present invention provides a memory associated with a programmable TV recorder storing computer readable instructions for programming a processor to monitor an input port capable of receiving schedule and software updates for a remote command, to extract a username and to verify the authority of the username using an identity verification protocol Preferably, the remote command is an electronic message generated by an internet-enabled client device.

According to a further aspect, the present invention provides a programmable recorder that can be remotely controlled and which records video signals, which includes monitoring circuitry, which monitors a signal stream for a recording recommendation, a processor which extract a username from the recording recommendation and which generate a match signal when stored usernames include the extracted username, and control circuitry, which effects a programmed response in response to the match signal. In an exemplary case, the programmed response includes addition of the recording recommendation to a recording schedule. In an alternative exemplary case, the programmed response includes addition of a recording recommendation to a list of recommended recording events. Beneficially, the programmable recorder further includes a communications circuit permitting communication between the programmable recorder and a schedule server; in that case, the monitoring circuitry monitors the signal stream received via the communications circuit for the recording recommendation

According to a still further aspect, the present invention provides a programmable recorder that can be remotely controlled and which records video signals, which includes monitoring circuitry, which monitors a signal stream for a remote command, a processor which extracts a username and a password from the remote command and which generates a match signal when extracted username and extracted password or other verification protocol match a stored username and associated password, and control circuitry, which effects an addition of a recording event identified in the remote command to a recording schedule in response to the mach signal. If desired, the programmable recorder includes a communications circuit permitting communication between the programmable recorder and a schedule server; in that case, the monitoring circuitry monitors the signal stream received via the communications circuit for the remote command.

According to yet another aspect, the present invention provides a programmable recorder that can be remotely controlled and which records video signals, which includes circuitry for monitoring a signal stream for one of a recording recommendation and a remote command, circuitry for extracting a username from the recording recommendation and for extracting a the username and associated password from a remote command, logic circuitry for distinguishing between the recording recommendation and the remote command based on the associated password, storage circuitry for storing the recording recommendation to a list of recommended recording events, and control circuitry for effecting the remote command to thereby modify the recording schedule, wherein the logic circuitry permits operation of only one of the storage circuitry and the control circuitry.

According to an additional aspect, the present invention provides a signal for remotely controlling the recording schedule of a programmable recorder including a controller which is responsive to the signal, the signal including a username, a verification protocol, and a named recording event, and which updates a recording schedule with respect to the named recording event when the username and verification protocol match stored data readable by the controller.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high-level block diagram of a personal television receiver (PTR);

FIG. 2 is a high-level block diagram of an entertainment system including the PTR illustrated in FIG. 1;

FIG. 3 is a more detailed block diagram of one preferred embodiment of a PTR according to the present invention;

FIG. 4 is a high level block diagram illustrating connections between several of the PTRs illustrated in figure to a server system operated by a service provider; and

FIGS. 5A and 5B are flow charts illustrating several methods for controlling the PTRs illustrated in FIG. 3 over the communications channels illustrated in FIG. 4.

### DETAILED DESCRIPTION OF THE PREFERRED EMBODIMENTS

Illustrative embodiments and exemplary applications will now be described with reference to the accompanying drawings to disclose the advantageous teachings of the present invention.

A typical PTR 100 includes a tuner 110, a MPEG-2 Encoder 120, a write random access memory (RAM) buffer 130, a disk drive 140, a read RAM buffer 150 and a MPEG-2 decoder 160 arranged in the order illustrated in FIG. 1. Each of these components is controlled by a CPU 300. Although identified as a MPEG-2 device, it should be noted that the video signal can be compressed using any intraframe or intTaframe and interframe compression technique; thus, the video signal can be stored in any known video data. It will also be noted that disk drive 140 is preferably a high capacity hard disk drive, preferably having a capacity of tens of gigabytes. CPU 300 can, for example, be used in a known fashion to program the tuner 110 to select and record programs from predetermined channels at predetermined times.

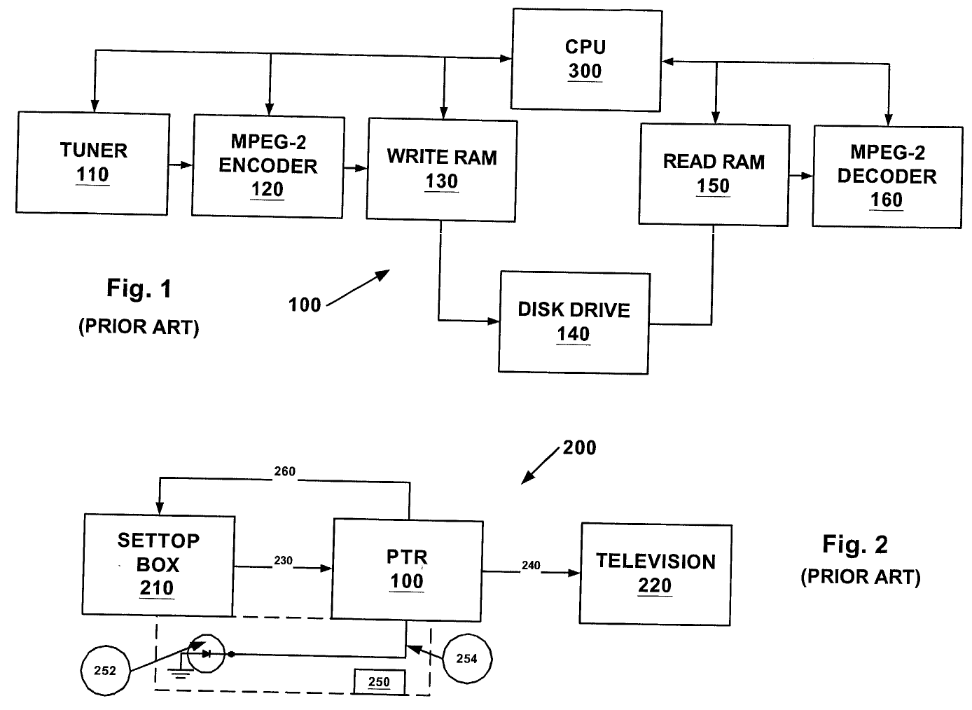

Consumers purchasing a PTR will often install the device between a conventional cable television settop box or satellite television receiver, hereinafter simply settop box, and a television set, as illustrated in FIG. 2. The settop box permits the consumers to continue to receive premium channels and the like which cannot be accessed via the cable ready tuner 110 in the PTR 100. FIG. 2 illustrates one possible arrangement of an entertainment system 200 wherein the settop box 210 is connected to a television 220 via the PTR 100. It will be noted that the cables 230 and 240, which connect settop box 210 to PTR 100 and PTR 100 to television 220, respectively, can be one of coaxial cable, audio/video (A/V) cable, or S-video cable. An additional control channel 250/260 is provided between the settop box 210 and the PTR 100, as discussed in greater detail immediately below.

Current models of the PTR 100 control channel selection on settop box 210 via a one-way communications channel 250, which can include an infrared transmitter 252, which is placed opposite the remote control IR sensor 212 on the settop box 210, and a cable 254. It should be noted that the control channel 250 can be replaced by a serial cable 260 connecting corresponding serial ports (not shown) of the settop box 210 and the PTR 100. Both the control channel 250 and the serial cable 260 permit the PTR 100 to select the channel output by the settop box 210.

As mentioned above, the preferred embodiments of the present invention provide improved Personal Television Receivers (PTRS) which include components and associated logic which enable each PTR to receive changes, and/or recommendations regarding, to a recording schedule from a remote location. Moreover, the PTR according to the present invention includes the ability to transmit schedule changes and recommended recording events to other individuals known to have PTR's of their own.

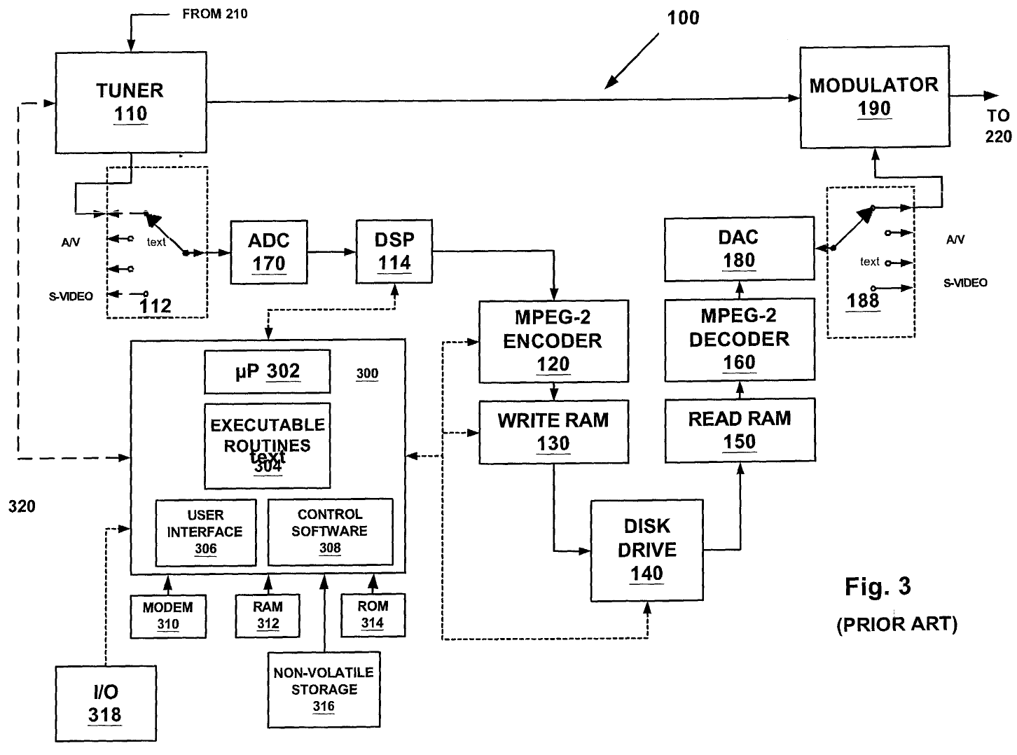

The preferred embodiment of a PTR 100 according to the present invention is illustrated greater detail in FIG. 3. More specifically, the PTR 100 includes a tuner 110 connected to a modulator 190, which allows the signal applied to one input terminal of the PTR 100 to be routed straight through to the television set 220. In will be appreciated that the input can be one of the output of settop box 210 or an antenna (not shown). The PTR 100 also includes a source selector 112, which can select between the signal generated by the tuner 110 or the A/V or S-video signals generated by the settop box 210. In any case, the output of selector 112 is provided to MPEG-2 encoder 120 via an analog-to-digital converter (ADC) 170. The MPEG-2 encoder 120, the write RAM 130, the disk drive 140, the read RAM 150 and the MPEG-2 decoder 160 are arranged in serial fashion in the exemplary embodiment illustrated in FIG. 3. The output of the MPEG-2 decoder 160 is applied to the input of digital-to-analog converter (DAC) 180, the analog output of which is routed by output selector 188 to either the modulator 190 or one of the A/V or S-video signal output ports of the PTR 110′. The PTR 100 also includes a digital signal processor (DSP) 114. Additionally, the PTR 100 includes paths permitting communication of commands and data between the DSP 114 and, in an exemplary case, the MPEG-2 encoder 120.

The PTR 100 illustrated in FIG. 3 advantageously includes a central processing unit (hereinafter “CPU”) 300 operatively coupled to a modem 310, a RAM 312, a non-volatile storage 316, a read-only memory (ROM) 314, and an input/output (I/O) device 318. It will be appreciated from the discussion above that the I/O 318 permits the CPU 300 to transmit settop box commands to the infrared (IR) transmitter 254 and to permit reception of control signals generated by any one of a remote control, a keyboard, a knob, a joystick, etc.

The CPU 300 illustrated in FIG. 3 advantageously can include one or more microprocessors 302, which are capable of executing stored program instructions (i.e., process steps) to control operations of the PTR 100. These program instructions comprise parts of software modules (described below) which are stored in either an internal memory 308 of the CPU 300 or in the ROM 314, and which are executed out of the RAM 312. These software modules may be updated via the modem 310. User profile information and the like is preferably stored in the non-volatile storage 314. In this regard, the non-volatile storage 314 may comprise a-flash EPROM, NVRAM, or the like, which is capable of being reprogrammed with, e.g., a new user profile, as desired.

FIG. 3 also illustrates examples of software modules, i.e., executable routines, 304 that are executable within the CPU 300. It will be appreciated that these executable routines 304 advantageously include the methods discussed in detail below. The microprocessor 302 receivers data and control signals transmitted via I/O 318 via user interface 306 and outputs control signals via the control module 308.

As mentioned above, the PTR 100 is connected to both a video source, e.g., an antenna, a settop box provided by a cable television company, a satellite receiver, etc., and a PTR service provider. The PTR incorporates a modem which is connected to a central server via a telephone system (POTS) line; the modem permits the PTR to download program schedules and operating software revisions on a regularly scheduled basis, e.g., daily.

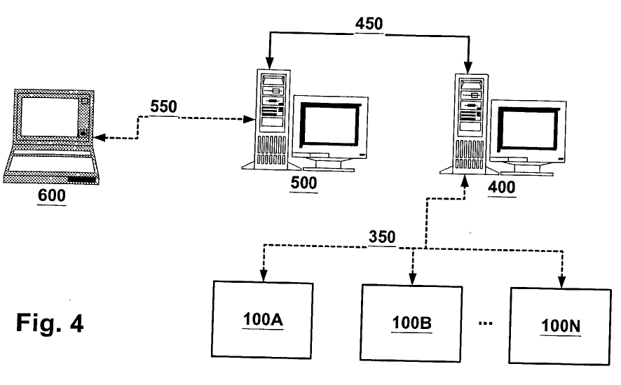

FIG. 4 is a high-level block diagram illustrating a number of PTRs 100A, 100B, . . . , 100N connected to a schedule server 400 operated by the PTR service provider. As mentioned previously, each of the PTRs 100A, 100B, . . . , 100N are connected to the schedule server 400 via POTS 350. In addition, FIG. 4 depicts an Internet enabled client 600, e.g., a computer or e-mail appliance, coupled to, for example, a mail server 500 via a wide area network 550. The mail server 500 transmits scheduling messages directed to any or all of the PTRs 100A, 100B, . . . , 100N to the schedule server 400 via a communications channel 450. It should be mentioned that the configuration illustrated in FIG. 4, and the various devices mentioned are exemplary only; various alternative configurations and arrangements would occur to one of ordinary skill in the art and all such alternatives are considered to be within the scope of the present invention.

As described below, software routines are included to enable remote users to program the recording schedule and other associated features of the PTR100. As is common with remote access networks, a verification protocol should be used in order to assure that only authorized users have access to the programming software and systems. Any known verification protocol can be used for this purpose, including simple comparison of a secret user password with a stored list, encrypted handshaking protocols of the type commonly used in cellular telephone systems and described in Canadian patent 1242501, public key protocols and the like.

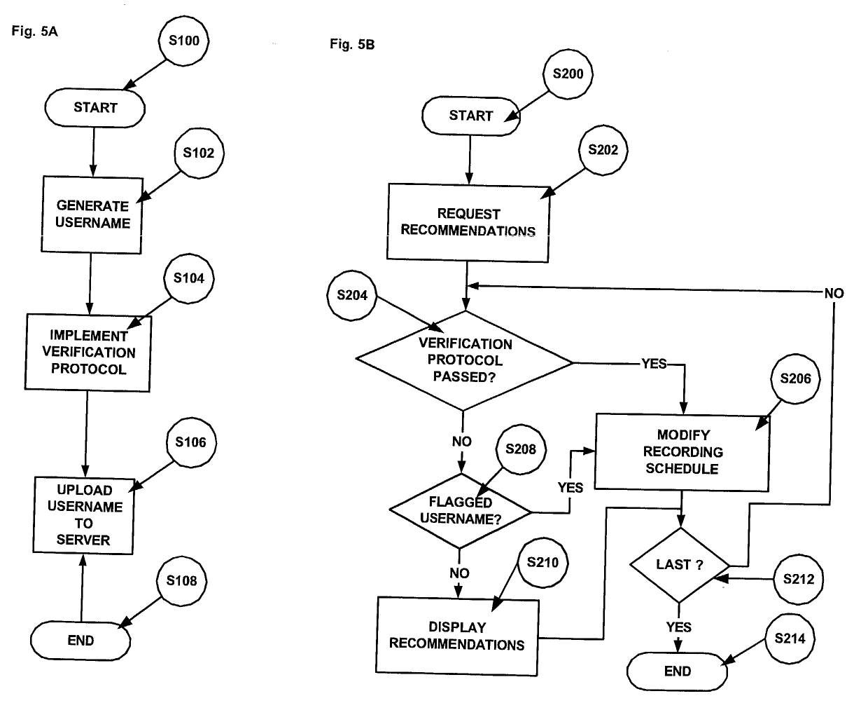

FIG. 5A is a flowchart illustrating steps employed in authorizing remote scheduling operations. As illustrated in FIG. 5A, the authorizing routine according to one exemplary embodiment the present invention starts a step S100, when the PTR 100 determines is shifted to the setup mode of operation. During step S102, the user generates a unique user name and enters the username in the non-volatile storage 316 associated with CPU 300 via either receipt of signals from a remote control device by the I/O device 318 or directly via the user interface 306. During step S104, the user generates a verification protocol list, which list is also stored in non-volatile storage 316. During step S106, the PTR 100 uploads the username to the schedule server 400, which can be stored along with the PTR 100's serial number, so that recommendations received from various users can be directed to the proper one of the PTR 100A, PTR 100B, . . . , PTR 100N. During step S108, the setup routine ends.

It should be noted that the verification protocol list advantageously could include a “secret” password known only to the owner and other usernames of respective other users within the users circle of friends and relations. It should also be noted that individual usernames in the verification protocol list can be flagged to differentiate recommendations from schedule changes. More specifically, recommended recording events sent by remote users with flagged usernames can be treated as schedule changers, i.e., the recommendation will be entered into the recording schedule, while recommended recording events sent with unflagged usernames will be treated as recommendations, i.e., these latter recommendations must be approved by the owner and only approved recommendations will be entered into the recording schedule. Thus, when a child receives a recommendation on his/her PTR 100B from the PTR 100A with the flagged username “PARENT,” that recommendation will be entered into the recording schedule without approval. On the other hand, a recommendation from the PTR 100N accompanied by an unflagged username “CASUAL FRIEND” will be presented to the owner of the PTR 100B for approval.

FIG. 5B is a flowchart illustrating one preferred embodiment of a routine by which the PTR 100A illustrated in FIG. 4 receives recommended recording events from remote users via the schedule server 400. During step S200, the PTR 100A loads the recommendation routine, preferably when the PTR establishes a connection with the schedule server 400 for its daily schedule update. It will be appreciated that the PTR 100A can also be programmed to poll the schedule server 400 for recommendations at a more frequent interval, depending on the users habits and the number of recommendations normally received by the owner. During step S202, the PTR requests that any recommendations addressed to the user, as indicated by the use of a username corresponding to the PTR 100A's assigned serial number, be transmitted to the PTR 100A.

During step S206, the CPU 300 of PTR 100A parses each received recommendation and determines whether the recommendation includes the verification protocol stored in non-volatile storage 318. When the determination at step S206 is affirmative, indicating that the secret verification protocol was present in the recommendation, the method embodied in PTR 100A jumps to step S206, during which the controller 300 updates the recording schedule. When the answer at step S204 is negative, the routine jumps to step S208 to determine whether the username of the person making the recommendation is a flagged username. When the answer is affirmative, the routine steps to step S206 and updates the recording schedule. When the answer is negative, the CPU 300 stores the recommendation in a recommendation list, which list can be displayed at the time determined by the owner of PTR 100A.

Whether step S206 or step S210 is performed, the routine then jumps to step S212 and determines whether the last recommendation received from the schedule server 400 has been processed. When the answer is negative, indicating that an additional recommendation has yet to be processed, the routine loops back to the beginning of step S204. When the answer is affirmative, the routine ends at step S214.

From the discussion above, it will be appreciated that one preferred embodiment of the present invention includes software, which enables each user to load an owner identifier name and verification protocol into the non-volatile storage 316 associated with the CPU 300 of the PTR 100A (using the keys on the remote control device) and to upload that name, via the modem 310 to the schedule server 400, where it is stored in a database associated with the PTR 100A=s serial number. This software program further allows the owner to input identifier names of other users (which are, for example, given to the user by friends and family who also own PTRs) and to send them, via the server and receiver modems, lists of program titles, times, etc., which the user of PTR 100A thinks that they may like to record or watch. The software also permits the owner to receive and display lists of programs, which are sent to them.

In most cases, the PTR would not normally record the recommended program without express approval by the owner. However, provisions can also be made in the software program to automatically record a program if the suggestion is sent together with an authorized verification protocol or is sent by any one of selected users. It will be appreciated that this latter feature will enable the owner to remotely program a PTR receiver from another location (some else's house or even from a second PTR in the same house) or to give a friend or family member authority to program the user's PTR while the user is out of town. It will also be appreciated that commands can also be transmitted to the server 400 via an internet connection, which would enable users to program their PTRs from an internet enable client device 600, e.g. a PC or PDA, from anywhere in the world.

It will be appreciated that the software needed to covert a conventional PTR into a remotely controllable PTR according to one aspect of the present invention advantageously can reside in a memory. In an exemplary case, the memory can be any of the memories associated with the CPU 300; preferably, the memory is one of ROM 314 and non-volatile storage 316.

It should be mentioned that the remote control functions available by implementation of the methods according to the present invention are not limited to implementation in a PTR. The inventive methods advantageously can be employed in other devices capable of recording television programs, e.g., in the television with hard disk drive disclosed in U.S. Pat. No. 6,172,712.

Thus, the present invention has been described herein with reference to a particular embodiment for a particular application. Those having ordinary skill in the art and access to the present teachings will recognize additional modifications applications and embodiments within the scope thereof. It is therefore intended by the appended claims to cover any and all such applications, modifications and embodiments within the scope of the present invention.

What is claimed is:

1. A memory associated with a programmable TV recorder storing a list of authorized usernames and computer readable instructions for programming a processor to monitor an input port capable of receiving schedule and software updates for a TV program recording recommendation, to extract a username from the recommendation, to compare the extracted username to the list of authorized usernames, and to accept the recommendation when the processor determines the extracted username is an authorized username.

2. The memory as recited in claim 1, wherein the step of accepting the recommendation comprises:
displaying for a list of recommendations in association with the username extracted from the recommendation;
allowing an owner of the programmable TV recorder to enable or reject each displayed recommendation on the list; and
recording TV programs identified in the enabled recommendations and not recording TV programs identified in the rejected recommendations.

3. The memory as recited in claim 2, wherein:
the list of usernames comprise a first group of usernames and a mutually exclusive second list of usernames; and
wherein the step of accepting the recommendations includes automatically enabling recommendations if the username extracted therefrom is in the first list and displaying on the list of recommendations other recommendations when the username extracted therefrom is on the second list

4. The memory as recited in claim 1, wherein the step of accepting the recommendation comprises recording a TV program which is identified in the recommendation.

5. A memory associated with a programmable TV recorder storing computer readable instructions for programming a processor to monitor an input port capable of receiving schedule and software updates for a remote command, to extract a username and verification protocol from the remote command, to compare the extracted username and verification protocol to a stored username and verification protocol, and to update a TV program recording schedule as instructed by the remote command when the processor determines that the stored username and verification protocol match the extracted username and verification protocol.

6. A programmable TV recorder that can be remotely controlled and which records television program signals, comprising:
monitoring circuitry, which monitors a signal stream for a program recording recommendation;
means which extract a username from the recording recommendation and which generate a match signal when stored usernames include the extracted username; and
control circuitry, which effects a programmed response in response to the match signal.

7. The programmable TV recorder as recited in claim 6, wherein the programmed response comprises addition of the recording recommendation to a recording schedule.

8. The programmable recorder as recited in claim 6, wherein the programmed response comprises addition of a recording recommendation to a list of recommended recording events.

9. The programmable recorder as recited in claim 6, wherein:
the programmable recorder further comprises a communications means for communication between the programmable recorder and a schedule server; and
monitoring means, for monitoring a signal stream received via the communications means for the recording recommendation.

10. The programmable recorder as recited in claim 6, wherein:
the stored usernames comprise a first list of usernames and a mutually exclusive second list of usernames;
the match signal comprises first and second match signals;
the means generate the first match signal when the extracted username is in the first list and the second match signal when the extracted username is in the second list;
the programmed response comprises addition of the recording recommendation to a recording schedule in response to the first match signal; and
the programmed response comprises addition of a recording recommendation to a list of recommended recording events in response to the second match signal.

11. A programmable television recorder that can be remotely controlled and which records TV program signals, comprising:
means for monitoring a signal stream for one of a recording recommendation and a remote command;
means for extracting a username from the recording recommendation and for extracting the username and associated verification protocol from a remote command;
means for distinguishing between the recording recommendation and the remote command based on the username and associated verification protocol;
means for storing the recording recommendation to a list of recommended recording events; and
means for effecting the remote command to thereby modify the recording schedule, wherein the distinguishing means permits operation of a selected one of the storing means and the effecting means.

12. The programmable recorder as recited in claim 11, wherein:
the programmable recorder further comprises means for communicating between the programmable recorder and a schedule server; and
the monitoring means monitors the signal stream received via the communicating means for the recording recommendation and the remote command.

13. A signal for remotely controlling the recording schedule of a programmable television recorder including a controller which is responsive to the signal, the signal comprising an electronic message including a username, a verification protocol, and an identification of a television program recommended for recording from a person who is identified by the username.
